(19) United States
(12) Patent Application Publication
(10) Pub. No.: US 2006/0218158 A1
(43) Pub. Date: Sep. 28, 2006

(54) Translation of information between schemas

(76) Inventors: Gunther Stuhec, Heidelberg (DE); Christian Drumm, Ulmet (DE)

Correspondence Address: FISH & RICHARDSON, P.C., PO BOX 1022, MINNEAPOLIS, MN, 55440-1022, US

(21) Appl. No.: 11/088,158

(22) Filed: Mar. 23, 2005

(51) Int. Cl. G06F 17/00

(52) U.S. Cl. 707/100

(57) ABSTRACT

A method of providing translation of information between schemas in a computer system includes creating a first mapping from a first schema to an intermediary schema, wherein information having an intermediary schema format can be translated to a second schema using a second mapping. For any portion of the first schema that cannot be mapped to the intermediary schema, a direct mapping from the portion of the first schema to the second schema is created. A method of translating information includes mapping information having a first schema format to an intermediary schema format using a first mapping. The information having the intermediary schema format is mapped to a second schema format using a second mapping. For any portion of the information having the first schema format that cannot be mapped to the intermediary schema format, the portion is mapped to the second schema format using a direct mapping.

### TECHNICAL FIELD

The description relates to translation of information between schema formats.

### BACKGROUND

Many aspects of electronic communication, and in particular electronic commerce, is based on business documents that parties can exchange over a computer connection. A big problem in current e-Business is the variety in structure and description of business information and business documents. The absence of uniform and standardized methods for the common representation of the structure and semantics of business data has led to today's situation where there is an increasing growth of different representations of electronic business information and documents. It may not be possible to exchange business documents electronically between two business partners without previous coordination and manual mapping between different document structures and semantics. A world-wide accepted syntax for representation exists with extensible markup language (XML), but this does not solve the problem of non-uniform semantics and structure.

Some business documents are based on reusable building blocks that define the semantics of the document data. An example of a standard that defines such building blocks is the electronic business XML (ebXML) Core Components Technical Specification issued by the United Nations Centre for Trade Facilitation and Electronic Business. This specification is also known as the ISO 15000-5 standard, and is hereafter referred to as CCTS. The CCTS is the first standard which combines all necessary aspects for human legibility and automatic machine processing so that an integrated interoperability can be guaranteed. The CCTS based building blocks are syntax free and very flexible, because they are based on a modular concept. Business information can be assembled for all demands by reusable building blocks. “Syntax free” means that these building blocks, called Core Components or “CCs”, can be generated in arbitrary representations, like XML, ABAP Objects or Java classes. However, the semantics described by the CCs in accordance with the CCTS do not change. This guarantees one general naming convention for the unambiguous composition of semantic information. A number of conventions within the CCTS (e.g., a naming convention) guarantee that the semantic information in each CC is unambiguous. This mechanism is comparable with the grammar and words of a naturally-spoken language, because a naturally-spoken language can also be represented in many different ways (by writing or by speech), and the semantics are always the same.

Sometimes, two enterprises that wish to transact electronic business use communication schemas that are incompatible with one another. If a system generates an electronic document using a first communication schema and sends the document directly to another system that uses a different communication schema, the other system is unable to interpret the electronic document because it lacks information for mapping business data elements between different schemas. The other system may therefore use a translation infrastructure to translate electronic documents from the first communication schema format to an intermediary communication schema format and then from the intermediary communication schema format to the second communication schema format.

While the use of intermediary schema formats is common, it may, however, have some disadvantages. Particularly, from time to time there is a need to integrate a new schema into the system. This tends to result in more and more extensions of the intermediary format. That is, due to structural and semantical mismatches in the different sources, the intermediary format is typically extended for the new format and, as a result, the intermediary schema continually grows and becomes more fragmented. In the end, such a situation may not offer any real advantage over creating direct mappings between the different sources.

### SUMMARY

The invention relates to translation of information between schemas.

In a first general aspect, a method of providing translation of information between schemas in a computer system comprises creating a first mapping from a first schema to an intermediary schema, wherein information having an intermediary schema format can be translated to a second schema using a second mapping. For any portion of the first schema that cannot be mapped to the intermediary schema, a direct mapping from the portion of the first schema to the second schema is created.

In selected embodiments, the use of the direct mapping is monitored over time to determine if the use meets a predefined criterion for extending the intermediary schema.

In a second general aspect, a method of translating information between schemas in a computer system comprises mapping information having a first schema format to an intermediary schema format using a first mapping. The information having the intermediary schema format is mapped to a second schema format using a second mapping. For any portion of the information having the first schema format that cannot be mapped to the intermediary schema format, the portion is mapped to the second schema format using a direct mapping.

In embodiments where the use of the direct mapping is monitored over time, a recommendation may be generated upon determining that the use meets a predefined criterion for extending the intermediary schema. The recommendation may be generated according to a procedure for recommending extensions of the intermediary schema. In response to the recommendation being generated, the system may receive an extension to the intermediary schema, the extension corresponding to the portion of the first schema. The extension may be created using information from the direct mapping.

In some embodiments, the direct mapping can be reused in mapping between a third schema and the second schema, the third schema being similar to the first schema.

In some embodiments, the intermediary schema is selected to correspond to an internal interface of the computer system.

Advantages of the systems and techniques described herein may include any or all of the following: Providing an improved translation between schemas; providing that a translation can be performed as a combination of a direct mapping and a mapping via an intermediary schema; reducing the need to extend an intermediary schema upon introducing a new schema; providing that the use of direct mappings is monitored and a recommendation for extending the intermediary schema is generated if the use meets a predefined criterion; providing a heuristic system that learns from already made mappings to improve future mappings; and providing reuse of direct mappings in translations that involve a similar schema.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 schematically illustrates translation from a first schema to a second schema;

FIG. 2 shows a computer system that can translate between schemas;

FIG. 3 shows a matcher module that can create mappings;

FIG. 4 schematically illustrates creation of a mapping from a first schema to an intermediary schema;

FIG. 5 shows exemplary mappings to the intermediary schema;

FIG. 6 schematically illustrates creation of a direct mapping between schemas;

FIGS. 7 and 8 are examples of methods relating to translation between schemas; and

FIG. 9 is a block diagram of a general computer system;

Like reference numerals in the various drawings indicate like elements.

### DETAILED DESCRIPTION

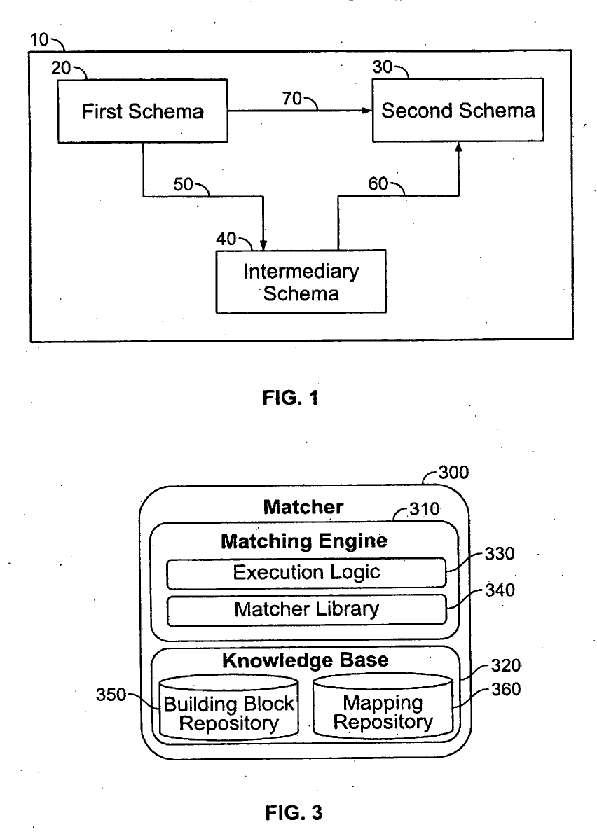

FIG. 1 shows a computer system 10 that includes at least a first schema 20 and a second schema 30. Documents created according to the first schema have a first schema format and documents created according to the second schema have a second schema format. The first and second schemas are different, meaning that a computer that is configured to understand only documents of the first schema format will not understand a document having the second schema format. However, a translation of the document can be provided through one or more mappings.

Particularly, the system may be provided with an intermediary schema 40 that is not identical to either of the first and second schemas. The intermediary schema may be based on the conventions of UN/CEFACT XML Naming and Design Rules for CCTS. Moreover, there can be created a first mapping 50 from the first schema to the intermediary schema. To the extent possible, the first mapping maps portions of the first schema to corresponding portions of the intermediary schema. Each portion describes an entity of a semantic meaning that belongs together. A second mapping 60 can then be used to map the translated portions from the intermediary schema to the second schema. Thus, at least part of the first schema can be mapped to the second schema through the intermediary schema.

It is possible, however, that one or more portions of the first schema cannot be mapped to the intermediary schema. The first schema may include a portion that has no corresponding portion in the intermediary schema. For example, the intermediary schema may lack a building block corresponding to a “buyer's agent”. To address this situation, there may be created a direct mapping 70 from the first schema to the second schema. The direct mapping relates to the portion of the first schema that cannot be mapped to the intermediary schema.

The system 10 can perform a translation of a document from the first schema format to the second schema format as follows. For every portion of the first schema, the system determines whether it can be mapped to the intermediary schema; that is, whether this portion is covered by the first mapping. If so, the system uses the first mapping to translate that aspect of the document to the intermediary schema format, and thereafter uses the second mapping for a further translation to the second schema format. For any portion that cannot be mapped to the intermediary schema, the translation may be performed using the direct mapping. Thus, any translation may be performed as a combination of mappings through the intermediary schema and direct mapping(s).

The use of the direct mapping can be monitored over time. Relatively frequent use of the direct mapping may indicate that it would be beneficial to replace the direct mapping with a mapping over the intermediary schema, because the latter can also be used in providing translation from the first schema to a format other than that of the second schema. In contrast, there may not be any significant advantage in extending the intermediary schema for direct mappings that are rarely used.

If the use over time of the direct mapping meets a predefined criterion, the system generates a recommendation to extend the intermediate schema. The intermediary schema can thereafter be extended such that the portion of the first schema to which the direct mapping relates can be mapped to the intermediary schema. The monitoring provides useful information about the mappings that are not covered by the intermediary schema. Also, comparing the monitored use with the predefined criterion provides that recommendations for extension of the intermediary schema are generated only for aspects that are most needed.

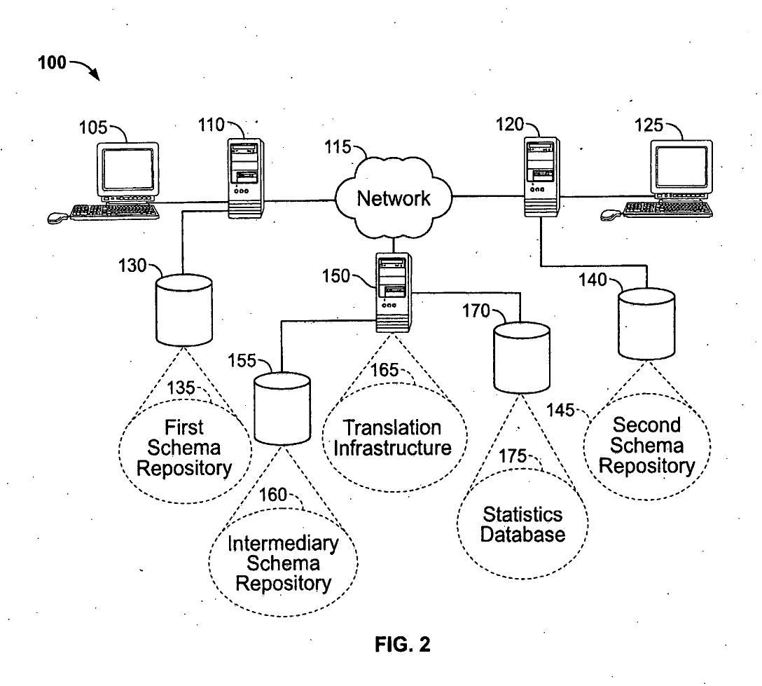

FIG. 2 is a block diagram of a system 100 for transacting electronic business using schemas. Particularly, the system 100 can translate documents from a first schema format to a second schema format using one or more mappings. The system 100 includes a first monitor 105 connected to a first computer 110 and a second monitor 125 connected to a second computer 120. Electronic business communications between the first computer 110 and the second computer 120 are conducted over a network 115, such as the Internet, in accordance with a business communication schema. To facilitate electronic business communications, the first computer 110 includes a data storage device 130 containing a first schema repository 135 and the second computer 120 includes a data storage device 140 containing a second schema repository 145. Each of the first schema repository 135 and the second schema repository 145 store metadata describing one or more formats defined by a business communication schema.

Particularly, the first schema repository stores the first schema 20 and uses it in creating and interpreting business documents. In particular, the first computer 110 organizes the data entered by the user according to a communication schema format and can then transmit the document over the network 115 to a receiving entity, such as the second computer 120. The second computer 120 is capable of interpreting received electronic documents in accordance with the metadata stored in the second schema repository 145. Particularly, the second schema repository stores the second schema 30 and uses it in creating and interpreting business documents.

An intermediary computer 150 is connected to the network 115 and includes a translation infrastructure 165 for translating the electronic document from the first schema format to the second schema format. The intermediary computer 150 includes a storage device 155 containing an intermediary schema repository 160. The intermediary schema repository 160 includes the first mapping 50, the second mapping 60 and the at least one direct mapping 70. Accordingly, the intermediary computer can translate the document using a combination of the mapping over the intermediary schema and the direct mapping, if necessary. For example, the translation infrastructure 165 can include the Exchange Infrastructure available from SAP AG of Walldorf (Baden), Germany.

A storage device 170 may contain a statistics database 175 that is used in collecting various data regarding the operation of the intermediary computer or the translation infrastructure. Particularly, the data obtained in monitoring use of the direct mapping may be deposited in the storage device. Regularly, or from time to time, the intermediary computer can analyze the database and determine whether the use meets the predefined criterion. The predefined criterion may correspond to how many times the direct mapping has been used, or how frequently it has been used, to name two examples. The same criteria may be used for several direct mappings.

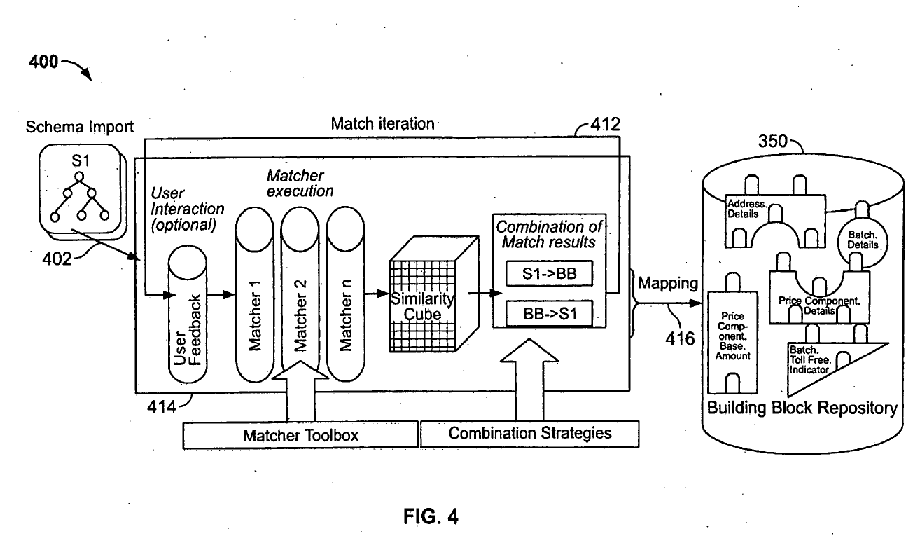

The mappings used in the translation may be created using one or more matching procedures. FIG. 3 shows a matcher module 300 that can perform such a procedure. For example, the matcher module can be included in the intermediary computer 150. The matcher module 300 includes a matching engine 310 that performs the procedure(s) and a knowledge base 320 that holds relevant information. The matching engine includes execution logic 330 and a matcher library 340. The knowledge base includes a building block repository 350 that includes the building blocks that make up the intermediary schema. For example, when the intermediary schema is CCTS-based, the building block repository includes building blocks defined by CCTS. The knowledge base also includes a mapping repository 360 in which to store 1) one or more mappings between a schema and the intermediary schema, and 2) one or more direct mappings between two schemas. For example, upon creation of the first and second mappings and the direct mapping shown in FIG. 1, each of them is stored in the mapping repository for use in translating documents.

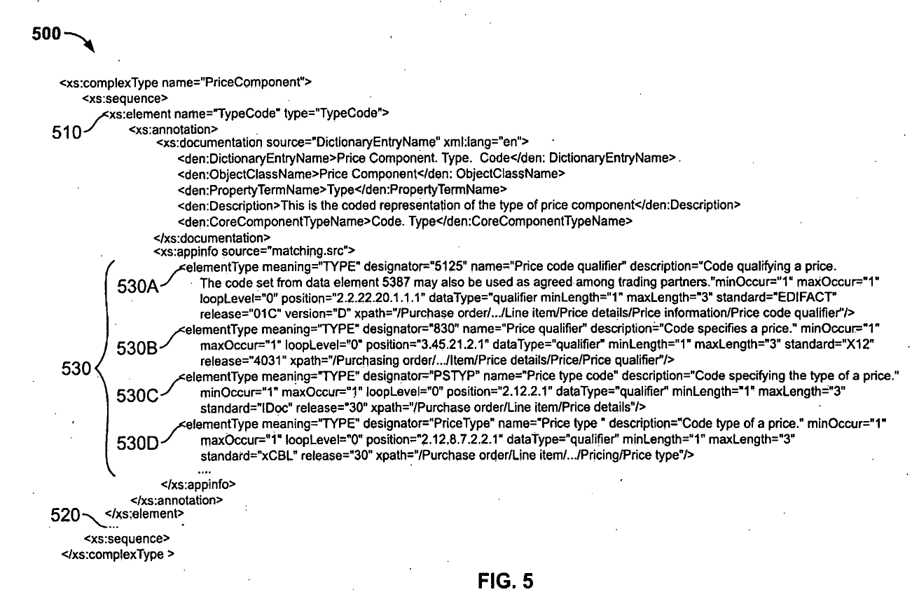

FIG. 4 schematically shows a procedure 400 that exemplifies how the first mapping 50 from the first schema to the intermediary schema can be created. The first schema is imported, as indicated by an arrow 402. The matching module 300 is used to apply one or more matching procedures to the first schema, as indicated by respective matcher components 404 labeled Matcher 1, Matcher 2, . . . , Matcher n. The matching procedure may be analogized to a toolbox where different tools (matching procedures) are sequentially applied to the schema to find a suitable match within the intermediary schema.

Any conventional and adaptive (heuristic) matching procedure may be used in creating the mapping(s). More simple matching procedures involve the use of a synonym library to compare leaf names in the first schema and the intermediary schema, or a node-by-node comparison of tree structures in the respective schemas. For example, the procedure may analyze the type of the schema component that is to be mapped. Other matching procedures may use a hybrid approach that also considers the descriptions that are available for the schemas.

The results of the matching procedure(s) may consist of probabilities associated with possible candidate building blocks in the intermediary schema. Each matching algorithm calculates a probability that any element X of the source schema maps to an element Y of the intermediary schema. If n number of matching algorithms are available and if the source schema has s number of elements and the intermediary schema has i number of elements, a total of n*s*i probability values will be calculated. The probability values may be represented as a similarity cube 406 having edges that correspond, respectively, to n, s and i values. The n probability values created by the n matchers of the element X corresponding to the element Y can then be combined into a final probability value using weights. A threshold value may be used to determine if the resulting probability for the mapping is sufficiently high.

The results are combined into a matching result at a combination stage 408. The matching result may include a “S1->BB” mapping 410A, corresponding to the mapping from the first schema to the building blocks in the intermediary schema. Similarly, the result may include a “BB->S1” mapping 410B, corresponding to the reverse mapping, from the intermediary building block(s) to the first schema. The latter mapping is, of course, intended to be used in translations to the first schema from other schemas, including the second schema.

The matching procedure may, however, not end with the first formulation of a result in the combination stage 408. Rather, the procedure may go through one or more iterations 412, in which the current results are tested against the respective schemas and re-evaluated for accuracy and robustness. Particularly, portions that have been found unmappable may be retried in light of the overall result. The procedure may allow user feedback 414 for portions that the matcher module has not successfully mapped. Nevertheless, some first-schema portions may be deemed unmappable after several iterations. For such portions, the matcher module can create a direct mapping. Moreover, by a learning procedure that involves direct comparison of already made mappings, such direct mappings may later be brought into the corresponding portion of the intermediary schema.

From the final results of the matching procedure the system forms a mapping from the first schema to the intermediary schema, with the possible exception of the unmappable portion(s). Particularly, the mapping provides the relation between the first schema and the building blocks of the intermediary schema, as schematically illustrated by an arrow 416. Examples of such building blocks in the building block repository are “Address. Details,” Batch. Details,”Price Component. Details,” “Price Component. Base. Amount” and “Batch. Toll Free. Indicator,” the names of which indicate their respective functions. The matcher module stores the created mapping in the mapping repository 360.

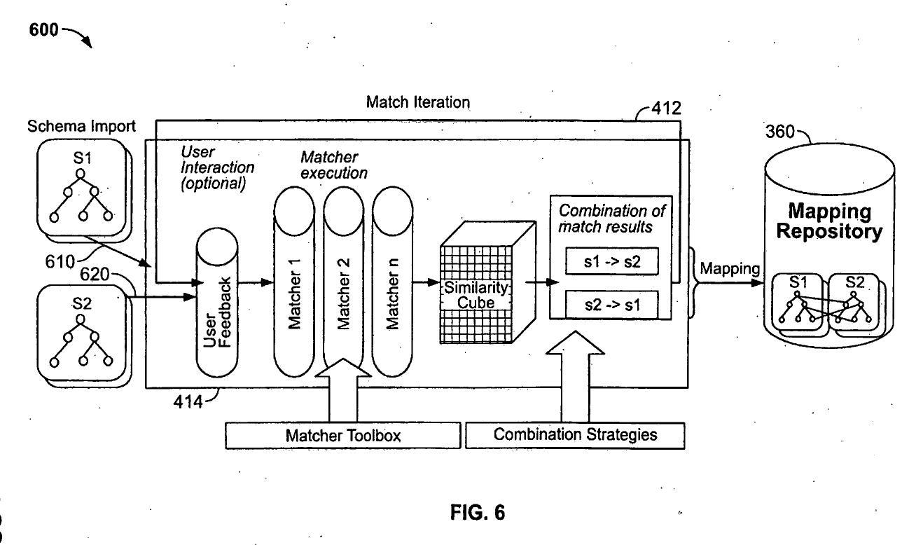

FIG. 5 shows an example of a mapping 500 to the intermediary schema. The mapping 500 covers translation of pricing information from several different schema formats. Particularly, this example shows how mapping information of other formats, represented within <element><appinfo: source=“matching.src”>in FIG. 5, is assigned to the appropriate CC of the intermediary format. This exemplary intermediary building block is a complex type.

The mapping 500 includes mapping information for one or more elements of the building block type. Here, a first element “TypeCode” 510 is shown, and other elements can be included, as indicated by an ellipsis 520. For the first element, the mapping 500 includes mapping information 530 relating to the different formats. For example, a first mapping information 530A relates to mapping from a portion of the EDIFACT schema to the TypeCode element. Similarly, a second mapping information 530B relates to mapping from a portion of the X12 schema to this element, a third mapping information 530C to mapping from an IDoc schema, and a fourth mapping information 530D to mapping from an XCBL schema. Mappings from fewer or more schemas may be included. Accordingly, upon translating from any of the formats just mentioned, the portion of the document relating to the specified building-block element will be mapped using the corresponding mapping information 530.

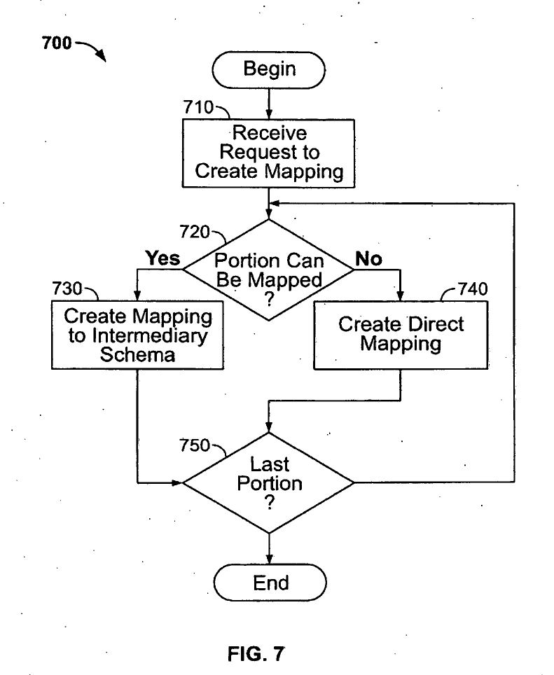

For portions that cannot be mapped to the intermediary schema, direct mapping(s) will be used. FIG. 6 schematically shows a procedure 600 that exemplifies how such a mapping can be created. For example, the procedure 600 may be used in creating the direct mapping 70 from the first schema to the second schema. The first and second schemas are imported, as indicated by respective arrows 610 and 620. Next, the matching module is used in an attempt to find a match between the two schemas for the portion to which the direct mapping relates. This may involve use of the one or more matching components 404 or of the similarity cube 406. An “S1->S2” mapping 630A and an “S2->S1” mapping 630B may result at the combination stage 408. Also, the iteration(s) 412 or the user feedback 414 may be provided, in analogy with the above description of the procedure 400.

The matcher module stores the direct mapping in the mapping repository 360. Thus, the mapping repository includes both mappings to and from the intermediary schema and direct mappings between different schemas. Either or both of these mapping categories may be used in translating a document. Also, the computer system may monitor the use of the direct mappings(s) to determine if there is a need to make an extension in the intermediary schema.

The direct mapping may be reused with a similar schema. That is, once the direct mapping is created, it may be determined that the portion of the first schema from which it maps to the second schema is similar to a portion of a third schema. For example, the third-schema portion may have a structure, name, definition or type that is similar to the first schema. Accordingly, the created direct mapping can be reused with the third schema. Optionally, the matcher module searches for such similarities in the matching procedure and can propose the reuse when appropriate.

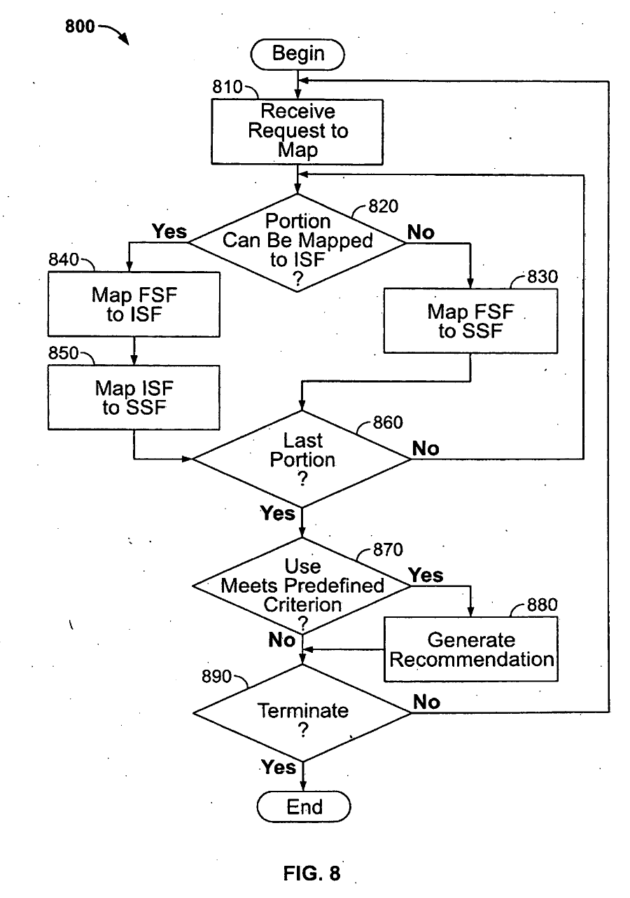

FIG. 7 is a flow chart of a method 700 relating to creation of mappings. The method may be performed in the system 10 or in the intermediary computer 150, to name two examples. A computer program product may include instructions that cause a processor to perform operations comprising the steps of the method. As shown in FIG. 7, the method 700 includes the following steps:

In step 710, a request to create a mapping is received. For example, the matcher module 300 can receive the request when the system needs to translate to or from a new format, such as upon the first schema 20 being introduced in the system. That is, based on the first schema. In step 720 the method therefore queries, for every portion of the first schema, whether the portion can be mapped to the intermediary schema. This may involve use of the matching component(s) 404. If the portion can be mapped, the method comprises creating, in step 730, the mapping to the intermediary schema. If not, the method comprises creating, in step 740, the direct mapping to the second schema. These mappings may be created at the combination stage 408 of the respective procedure 400 or 600, optionally after iteration(s) and user feedback. In step 750, it is ensured that the sequence of steps 720 and 730/740 is carried out for every portion of the first schema. The created schema(s) may be stored in the mapping repository 360 for use in translations.

FIG. 8 is a flow chart of a method 800 relating to use of mappings. The method may be performed in the system 10 or in the intermediary computer 150, to name two examples. A computer program product may include instructions that cause a processor to perform operations comprising the steps of the method. As shown in FIG. 8, the method 800 includes the following steps:

In step 810, there is received a request to map between schemas. For example, the request may be generated upon the system receiving a document that has the first schema format and that is to be translated into the second schema format. Accordingly, each portion of the document should be mapped to the second schema. In step 820, it is therefore determined, for each portion of the information in the document, whether the portion can be mapped to the intermediary schema format (ISF). If the portion cannot be so mapped, the method comprises mapping the portion to the second schema format (SSF) in step 830. This involves using the direct mapping 70.

If, in contrast, step 820 shows that the portion can be mapped, then the method comprises mapping, in step 840, the portion having the first schema format (FSF) to the intermediary schema format. This involves using the first mapping 50. The method also comprises mapping, in step 850, the information having the intermediary schema format to the second schema format. This involves using the second mapping 60. In other implementations, the step 850 can be performed later in the process, such as when the whole document has been evaluated as to whether the mapping should be direct or through the intermediary schema. Step 860 ensures that the step 820 and the appropriate mapping is performed for every portion of the document.

The above steps can be repeatedly or simultaneously performed for translation of many documents. Here, the system monitors, over time, use of the direct mapping(s) in such translations. In step 870, it is determined whether the use meets a predefined criterion for extending the intermediary schema. If it does, a recommendation can be generated in step 880. The recommendation can identify the direct mapping(s) and the involved schemas, to name two examples. When there exists a procedure for recommending extensions of the intermediary schema, such a procedure may be followed in step 880. For example, CCTS defines a procedure for recommending extensions of the building blocks defined by this standard. The procedure specifies that the existing building blocks are analyzed to determine whether it would be sufficient to re-use or change an existing building block, or whether a new building block should be requested. Also, the recommendation should follow the naming conventions of the standard.

The above aspects of the method 800 can be performed repeatedly for several translations until the method is terminated (step 890).

If a recommended extension is implemented, the intermediary schema 40 is updated or replaced, and the mappings are revised accordingly. That is, the extension corresponds to ensuring that the intermediary schema covers a currently unmappable portion of the first schema. As a result, the system should revise the existing first mapping such that it performs also the extended mapping from the first schema. Also, the direct mapping may be eliminated upon making such an extension.

Several different schemas may be used as the intermediary schema 40. In some implementations, it is CCTS-based. For example, the primary building blocks used in the SAP NetWeaver™ technology are the SAP Global Data Types (GDTs). New applications based on SAP NetWeaver™ use SAP GDTs exclusively. This means that the SAP GDTs correspond to a common interface used by applications and this provides increased flexibility and simplicity in the translation of business information that such a computer system imports or exports. Thus, the intermediary schema may be selected such that it corresponds to an internal interface of the computer system. Moreover, because the direct mapping includes ample semantical and structural information, an appropriate entity of the intermediary schema format can be created from the information in the direct mapping.

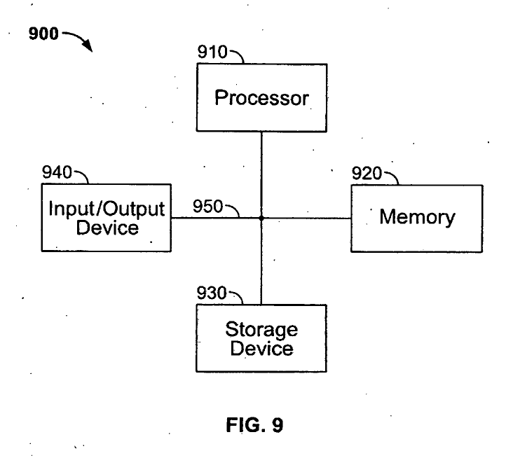

FIG. 9 is a block diagram of a computer system 900 that can be used in the operations described above, for example in the system 10 or in the intermediate computer 150. The system 900 includes a processor 910, a memory 920, a storage device 930 and an input/output device 940. Each of the components 910, 920, 930 and 940 are interconnected using a system bus 950. The processor 910 is capable of processing instructions for execution within the system 900. In one embodiment, the processor 910 is a single-threaded processor. In another embodiment, the processor910 is a multi-threaded processor. The processor 910 is capable of processing instructions stored in the memory 920 or on the storage device 930 to display graphical information for a user interface on the input/output device 940.

The memory 920 stores information within the system 900. In one embodiment, the memory 920 is a computer-readable medium. In one embodiment, the memory 920 is a volatile memory unit. In another embodiment, the memory 920 is a non-volatile memory unit.

The storage device 930 is capable of providing mass storage for the system 900. In one embodiment, the storage device 930 is a computer-readable medium. In various different embodiments, the storage device 930 may be a floppy disk device, a hard disk device, an optical disk device, or a tape device.

The input/output device 940 provides input/output operations for the system 900. In one embodiment, the input/output device 940 includes a keyboard and/or pointing device. In one embodiment, the input/output device 940 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method of providing translation of information between schemas in a computer system, the method comprising:
creating a first mapping from a first schema to an intermediary schema, wherein information having an intermediary schema format can be translated to a second schema using a second mapping; and
for any portion of the first schema that cannot be mapped to the intermediary schema, creating a direct mapping from the portion of the first schema to the second schema.

2. The method of claim 1, further comprising providing that use of the direct mapping is monitored over time to determine if the use meets a predefined criterion for extending the intermediary schema.

3. The method of claim 1, further comprising selecting the intermediary schema to correspond to an internal interface of the computer system.

4. The method of claim 1, wherein creating at least one of the first mapping and the direct mapping involves executing a matching algorithm on the first schema.

5. The method of claim 4, wherein executing the matching algorithm includes an iterative process that permits user input to create the at least one of the first mapping and the direct mapping.

6. The method of claim 1, wherein the portion of the first schema cannot be mapped to the intermediary schema because it has no corresponding portion in the intermediary schema.

7. The method of claim 1, wherein the intermediary schema is based on CCTS.

8. A computer program product tangibly embodied in an information carrier, the computer program product including instructions that, when executed, cause a processor to perform operations comprising:
creating a first mapping from a first schema to an intermediary schema, wherein information having an intermediary schema format can be translated to a second schema using a second mapping; and
for any portion of the first schema that cannot be mapped to the intermediary schema, creating a direct mapping from the portion of the first schema to the second schema.

9. A method of translating information between schemas in a computer system, the method comprising:
mapping information having a first schema format to an intermediary schema format using a first mapping;
mapping the information having the intermediary schema format to a second schema format using a second mapping; and
for any portion of the information having the first schema format that cannot be mapped to the intermediary schema format, mapping the portion to the second schema format using a direct mapping.

10. The method of claim 9, further comprising monitoring use of the direct mapping over time in the computer system.

11. The method of claim 10, further comprising generating a recommendation upon determining that the use meets a predefined criterion for extending the intermediary schema.

12. The method of claim 11, wherein the recommendation is generated according to a procedure for recommending extensions of the intermediary schema.

13. The method of claim 11, further comprising receiving an extension to the intermediary schema in response to generating the recommendation, the extension corresponding to the portion of the first schema.

14. The method of claim 13, wherein the extension is created using information from the direct mapping.

15. The method of claim 9, further comprising reusing the direct mapping in mapping between a third schema and the second schema, the third schema being similar to the first schema.

16. The method of claim 9, wherein the intermediary schema is selected to correspond to an internal interface of the computer system.

17. A computer program product tangibly embodied in an information carrier, the computer program product including instructions that, when executed, cause a processor to perform operations comprising:
mapping information having a first schema format to an intermediary schema format using a first mapping; mapping the information having the intermediary schema format to a second schema format using a second mapping; and
for any portion of the information having the first schema format that cannot be mapped to the intermediary schema format, mapping the portion to the second schema format using a direct mapping.

18. The computer program product of claim 17, wherein the operations further comprise:
monitoring use of the direct mapping over time in the computer system.

19. The computer program product of claim 18, wherein the operations further comprise:
generating a recommendation upon determining that the use meets a predefined criterion for extending the intermediary schema.

20. The computer program product of claim 19, wherein the recommendation is generated according to a procedure for recommending extensions of the intermediary schema.
